(19) United States
(12) Patent Application Publication
(10) Pub. No.: US 2023/0183025 A1
(43) Pub. Date: Jun. 15, 2023

(54) Conveying system, dip-coating system and method for dip-coating a workpiece

(71) Applicant: Wenker GmbH & Co. KG, Ahaus (DE)

(72) Inventor: Franz LEERS, Ahaus (DE)

(73) Assignee: Wenker GmbH & Co. KG, Ahaus (DE)

(21) Appl. No.: 18/080,065

(22) Filed: Dec. 13, 2022

(30) Foreign Application Priority Data
Dec. 14, 2021 (DE) 10 2021 133 122.6

(51) Int. Cl. B65G 49/04; B25J 11/00

(52) U.S. Cl. CPC B65G 49/0409; B25J 11/0075; B65G 2201/0223

(57) ABSTRACT

A conveying system for a dip-coating system has at least one conveying unit that can be moved parallel to a conveying direction, in which workpieces to be treated can be conveyed through the dip-coating system, along a dip-coating tank of the dip-coating system, with which unit at least one workpiece to be treated can be moved in the conveying direction and at the same time can be dipped in a dipping bath contained in the dip-coating tank. The conveying system has at least one runway that can be disposed laterally beside the dip-coating tank, wherein the conveying unit has a powered vehicle of at least double-tracked and steerable construction, which is disposed with the ability to travel on the runway for conveying of the workpiece.

### TECHNICAL FIELD

The invention relates to a conveying system for a dip-coating system having at least one conveying unit that can be moved parallel to a conveying direction, in which workpieces to be treated can be conveyed through the dip-coating system, along a dip-coating tank of a dip-coating system, with which unit at least one workpiece to be treated can be moved in the conveying direction and at the same time can be dipped in the dipping bath contained in the dip-coating tank. In addition, the invention relates to a dip-coating system having at least one dip-coating tank and at least one conveying system for conveying of workpieces to be treated in a conveying direction through the dip-coating system. Furthermore, the invention relates to a method for dip-coating of a workpiece, wherein the workpiece to be treated is moved in a conveying direction through the dip-coating system and at the same time is dipped in a dipping bath contained in a dip-coating tank.

### PRIOR ART

Dip-coating systems are used in particular in the series production of metallic workpieces with complex geometry, such as motor-vehicle bodies, for example. Such a workpiece is dipped in a dip-coating system in a dipping bath contained in a dip-coating tank and comprising a treatment liquid. Hereby a corrosion-protection coating can be applied on the workpiece by, for example electrophoretic deposition (EPD), especially by cathodic dip painting (CDP).

A conventional dip-coating system has a conveying system, with which the workpieces to be treated can be conveyed in a conveying direction through the dip-coating system. A conventional conveying system may have a multiplicity of conveying units that can be moved parallel to the conveying direction along a dip-coating tank, with which units respectively one workpiece to be treated can be moved in the conveying direction and at the same time can be dipped in the dipping bath contained in the dip-coating tank. Usually the conveying units are guided in compulsory manner along at least one rail, as is known, for example, from DE 10 2019 110 552 A1.

### DISCLOSURE OF THE INVENTION

One task of the invention is to configure the conveying of workpieces through a dip-coating system more flexibly, to simplify it technically and thus to make it more cost-effectively feasible.

This task is accomplished by the independent claims. Advantageous configurations are rendered in the dependent claims, the following descriptions and the figures, wherein these configurations may respectively represent an advantageous and/or further developed aspect of the invention taken in itself or a combinations of at least two of these configurations with one another. In this context, advantageous configurations of the conveying system and/or of the dip-coating system may correspond to advantageous configurations of the method and vice versa, even if this is not explicitly mentioned in the following.

A conveying system according to the invention for a dip-coating system has at least one conveying unit that can be moved parallel to a conveying direction, in which workpieces to be treated can be conveyed through the dip-coating system, along a dip-coating tank of a dip-coating system, with which unit at least one workpiece to be treated can be moved in the conveying direction and at the same time can be dipped in a dipping bath contained in the dip-coating tank, plus at least one runway that can be disposed laterally beside the dip-coating tank, wherein the conveying unit has a powered vehicle of at least double-tracked and steerable construction, which is disposed with the ability to travel on the runway for conveying of the workpiece.

According to the invention, the conveying unit is not guided in compulsory manner on a rail system but instead is constructed as a self-driving conveying unit, which has the ability to travel on the runway that can be disposed laterally beside the dip-coating tank. For this purpose, the conveying unit is provided with the powered vehicle of double-tracked and steerable construction, i.e. a vehicle having its own drive. Thus the complex installation of a conventional rail system or the like is obviated in the conveying system according to the invention, whereby the conveying of workpieces through the dip-coating system is technically simplified and thus is made more cost-effectively feasible.

The runway may have a level runway surface, on which the powered vehicle is able to travel. Preferably the runway surface is free of tracks. However, the invention can also be realized with a runway surface that has irregularities, for example an embedded rail or the like. What is essential is that the runway surface is of such nature that the powered vehicle is able to travel safely on the runway and that preferably no running wheel of the powered vehicle loses contact completely with the runway while driving over the runway. For example, the runway may have a road-like surface.

Since the conveying unit or its powered vehicle is of steerable construction, the runway may be adapted without great complexity to the respective circumstances and requirements, because the conveying unit is also able to follow more complex runway trajectories well. The conveying unit or its powered vehicle may have four running wheels with which it travels over the runway. Alternatively, the conveying unit or its powered vehicle may have running-wheel units provided with two running wheels that can turn around a common turning axis and that can be disposed together with the ability to swivel around a vertical steering axis.

For example, the powered vehicle may be constructed in a manner corresponding to DE 20 2014 000 755 U1. The disclosure content of DE 20 2014 000 755 U1 is herewith incorporated in full scope into the disclosure content of the present application.

Preferably, the conveying system has a multiplicity of conveying units, especially of identical construction, which have the ability to travel on the runway, especially individually and/or freely.

For example, a workpiece in the form of a vehicle body may be conveyed with the conveying unit through the dip-coating system.

According to an advantageous configuration, the powered vehicle is an electric vehicle. For this purpose, the powered vehicle may have at least one electric drive motor, at least one traction battery and at least one power electronics unit, which controls and/or regulates a supply of the drive motor with electrical energy drawn from the traction battery. The powered vehicle may also have at least one electric drive motor for each track or a separate electric drive motor for each running wheel or for each running-wheel unit described above.

According to a further advantageous configuration, the powered vehicle is set up for autonomous driving. Hereby the powered vehicle is able to drive autonomously over the runway while taking surrounding information detected by sensors into consideration, without the need for an external intervention. Alternatively or additionally, markings detectable by sensors, for example of optical or electromagnetic type, by means of which the powered vehicle is able to orient itself at least partly while driving over the runway, may be disposed on the runway. Alternatively, the powered vehicle may be externally remote-controlled, for example via a radio link or the like.

According to a further advantageous configuration, the runway has a conveying portion that can be disposed laterally beside the dip-coating tank, a return portion disposed on a side of the conveying portion applied to the dip-coating tank, and two transition portions respectively joining the conveying portion and the return portion end-to-end with one another, wherein these portions of the runway are formed by a surface equipped with runway limiters or by a surface free of runway limiters.

During conveying of the workpiece through the dip-coating system, the powered vehicle travels over the conveying portion of the runway. At the end of the conveying portion, the workpiece is removed from the conveying unit. Then the conveying vehicle is able to travel over the one transition portion of the runway onto the return portion of the runway, via which the conveying unit arrives at the next transition portion of the runway and from this ultimately at the beginning of the conveying portion of the runway, where a further workpiece to be treated can be disposed on the conveying unit or can be received autonomously or automatically by the conveying unit, of the conveying unit for example by moving a component part, especially the holding cantilever arm, mentioned below, under a portion of the workpiece and then lifting the component part together with the workpiece. If these portions of the runway are formed by a surface equipped with runway limiters, it is possible to prevent the conveying unit from straying from its optimal path. In contrast, if the runway is formed by a surface free of runway limiters, the runway can be made very cost-effectively, for example by using simply a floor, for example shop floor, situated next to the dip-coating tank as the runway, without the need to modify the said floor.

According to a further advantageous configuration, the conveying unit has, for holding the workpiece and carried by the powered vehicle, at least one holding unit, which has at least one holding cantilever arm and at least one counterweight, wherein the counterweight is disposed in such a way relative to the holding cantilever arm that moments acting on the powered vehicle via the holding cantilever arm loaded with the workpiece can be at least balanced out with the counterweight. The holding unit is disposed on the powered vehicle or is carried by it. Due to the counterweight, the conveying unit loaded with the workpiece can be reliably prevented from tilting while driving over the runway. Preferably, the counterweight can be exchanged in simple manner and/or is of modular design comprising individual weight units, so that the counterweight can be adapted in simple manner to the moments respectively to be expected or acting on the holding unit or on the powered vehicle. The holding cantilever arm may be aligned horizontally, at least in its holding position, in which it holds the workpiece.

According to a further advantageous configuration, the holding cantilever arm is disposed around a horizontal turning axis with the ability to turn on the rest of the holding unit. Hereby the holding cantilever arm can be turned around the turning axis, whereby the workpiece disposed on the holding cantilever arm can be turned or displaced around the turning axis. For example, to begin with, the workpiece may thereby be disposed partly or completely above the holding cantilever arm. As soon as the workpiece is disposed in this relative position partly or completely above the dip-coating tank, the holding cantilever arm can be turned around the turning axis, so that the workpiece is dipped, especially completely, into the dip-coating tank and, for example, is situated upside-down in the dip-coating tank. Thereafter the holding cantilever arm can be turned again in the same direction or in the opposite direction around the turning axis, until the workpiece that has now been treated is again disposed partly or completely above the holding cantilever arm and outside the dip-coating tank. During these turning movements of the holding cantilever arm, the powered vehicle is able to travel over the runway, whereby a more complex movement of the workpiece relative to the dip-coating tank can be generated. The holding unit and/or the powered vehicle may have at least one electrically activatable positioning drive for swiveling of the holding cantilever arm around the turning axis.

According to a further advantageous configuration, the holding cantilever arm has at least one holding portion that can be connected to the workpiece and detached from it nondestructively, and, relative to the rest of the holding cantilever arm, is offset laterally from the horizontal turning axis. Hereby the diameter of the circular movement path, imposed relative to the longitudinal extent of the holding cantilever arm, of the workpiece disposed on the holding cantilever arm being turned around the horizontal turning axis is larger, so that the workpiece can be dipped into the dipping bath contained in the dip-coating tank without absolutely needing a stroke of the holding cantilever arm for this purpose. The workpiece is preferably connected to the holding portion of the holding cantilever arm exclusively mechanically, for example interlockingly.

According to a further advantageous configuration, at least one mushroom pin that can be connected with the workpiece is disposed laterally on the holding cantilever arm. For example, the mushroom pin may be inserted in a keyhole-shaped opening in the workpiece and displaced relative to the workpiece so as to engage behind a workpiece portion forming the opening, wherein these processes can be brought about by a movement of the workpiece relative to the holding cantilever arm when the workpiece is disposed on the holding cantilever arm. By an inversion of these processes, the treated workpiece can be released from the holding cantilever arm once again. Two or more mushroom pins may also be disposed spaced apart from one another on the holding cantilever arm, especially on its holding portion. The holding portion may have, extending parallel to one another and spaced apart from one another as well as extending transversely relative to the rest of the holding cantilever arm or to the horizontal turning axis, two crossbeams, on which respectively at least two mushroom pins may be disposed.

According to a further advantageous configuration, the holding cantilever arm is disposed in vertically displaceable relationship on the rest of the holding unit. Accordingly, the holding cantilever arm may therefore be displaced vertically by a predetermined distance (stroke movements) relative to the rest of the holding unit. Thereby the holding cantilever arm equipped with the workpiece disposed outside the dip-coating tank may be lowered, especially for dipping of the workpiece into the dipping bath contained in the dip-coating tank. In addition, this stroke movement of the holding cantilever arm may be coordinated in such a way with the travel movement of the conveying unit relative to the dip-coating tank that a dipping bath and thus a dip-coating tank of shallower depth may be used for dip-coating of the workpiece, thus saving overall space, material and costs. The holding unit and/or the powered vehicle may have at least one electrically activatable positioning drive for vertical displacement of the holding cantilever arm relative to the rest of the holding unit.

According to a further advantageous configuration, the holding cantilever arm is disposed around a vertical swivel axis with the ability to swivel on the rest of the holding unit, or the holding unit is disposed around the vertical swivel axis with the ability to turn on the powered vehicle. Hereby the holding cantilever arm can be swiveled by approximately 90°, for example, once the treated workpiece has been removed from the holding cantilever arm, so that the conveying unit is of more compact and more space-saving construction and in this condition is able to travel back to the beginning of the above-mentioned conveying portion of the runway with relatively small space requirement. Having arrived there, the holding cantilever arm can be swiveled by approximately 90° in the opposite direction, so that a further workpiece to be treated can be disposed on the conveying unit and carried along or transported by it. The holding unit and/or the powered vehicle may have at least one electrically activatable positioning drive for swiveling of the holding cantilever arm around the vertical swivel axis relative to the rest of the holding unit or for turning the holding unit relative to the powered vehicle.

A dip-coating system according to the invention has at least one dip-coating tank and at least one conveying system for conveying of workpieces to be treated in a conveying direction through the dip-coating system, wherein the conveying system is formed according to one of the above-mentioned configurations or a combination of at least two of these configurations with one another.

The advantages mentioned above with reference to the conveying system are associated correspondingly with the dip-coating system. For example, the dip-coating system may be set up for performance of an electrophoretic deposition (EPD), especially for cathodic dip painting (CDP).

According to an advantageous configuration, the runway is formed by a shop floor or is braced against the shop floor by means of a load-bearing substructure. In the first of the above-mentioned alternatives, the dip-coating tank may be partly or completely embedded in a floor. In the second of the above-mentioned alternatives, the dip-coating tank may be mounted on a floor.

According to a method according to the invention for dip-coating of a workpiece, the workpiece to be treated is moved in a conveying direction through the dip-coating system and at the same time is dipped into a dipping bath contained in a dip-coating tank, wherein the workpiece to be treated is moved by means of at least one conveying unit, which travels on a runway disposed laterally beside the dip-coating tank and has a powered vehicle of at least double-tracked and steerable construction.

The advantages mentioned above with reference to the conveying system are associated correspondingly with the method. In particular, the conveying system may be used according to one of the above-mentioned configurations or a combination of at least two of these configurations with one another in order to perform the method.

In the following, the invention will be explained by way of example on the basis of preferred embodiments with reference to the attached figures, wherein the features explained in the following may respectively represent both an advantageous and/or further developed aspect taken in itself and a different combination with one another.

### BRIEF DESCRIPTION OF THE FIGURES

Therein:

FIG. 1 shows a schematic diagram of an exemplary embodiment of a dip-coating system according to the invention;

FIG. 2 shows a schematic diagram of a further exemplary embodiment of a dip-coating system according to the invention;

FIG. 3 shows a schematic and perspective diagram of a conveying unit with lowered holding cantilever arm of a further exemplary embodiment of a dip-coating system according to the invention;

FIG. 4 shows a schematic and perspective diagram of the conveying unit shown in FIG. 3 with raised holding cantilever arm; and

FIG. 5 shows a schematic and perspective diagram of the conveying unit shown in FIG. 3 with horizontally swiveled holding cantilever arm.

### DETAILED DESCRIPTION OF THE FIGURES

Like and functionally similar component parts are denoted with the same reference symbols in the figures. A repeated description of such component parts in detail can be omitted for avoidance of unnecessary repetitions.

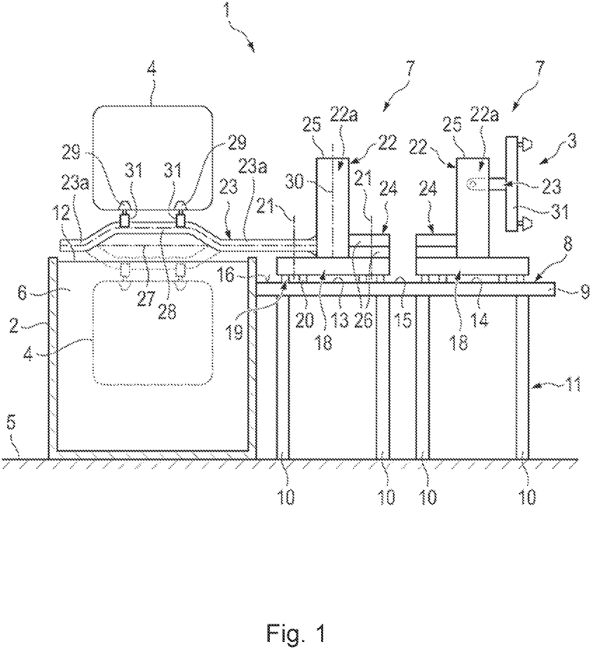

FIG. 1 shows a schematic diagram of an exemplary embodiment of a dip-coating system 1 according to the invention with a dip-coating tank 2 and a conveying system 3 for conveying of workpieces 4 to be treated in a conveying direction, oriented perpendicular to the plane of the drawing, through the dip-coating system 1. The dip-coating tank 2 is mounted on a shop floor 5 and contains a dipping bath 6.

The conveying system 3 has several conveying units 7 that can be moved parallel to the conveying direction along the dip-coating tank 2, with which units respectively a workpiece 4 to be treated can be moved in the conveying direction and at the same time can be dipped in the dipping bath 6 contained in the dip-coating tank 2. Only two of the conveying units 7 are shown in FIG. 1, wherein the conveying unit 7 shown on the left is situated in a conveying mode and the conveying unit 7 shown on the right is situated in a return mode, as will become more apparent from the following description.

In addition, the conveying system 3 has a runway 8 disposed laterally beside the dip-coating tank 2. The runway 8 is formed by a platform 9, which is braced by means of props 10 against the shop floor 5. The platform 9 and the props 10 form a load-bearing substructure 11, via which the runway 8 is braced against the shop floor 5. The runway 8 is disposed geodetically lower than the upper rim of the dip-coating tank 2 and geodetically higher than a surface level 12 of the dipping bath 6.

The runway 8 has, disposed laterally beside the dip-coating tank 2, a conveying portion 13, on which the conveying unit 7 shown on the left of FIG. 1 is traveling away from the observer of FIG. 1. Furthermore, the runway 8 has, on a side of the conveying portion 13 applied to the dip-coating tank 2, a return portion 14, on which the conveying unit 7 shown on the right of FIG. 1 is traveling toward the observer of FIG. 1. In addition, the runway 8 has, respectively joining the conveying portion 13 and the return portion 14 end-to-end with one another, two transition portions 15, of which only one transition portion 15 is shown in FIG. 1. These portions 13, 14 and 15 of the runway 8 are formed by a surface 16 that is free of runway limiters. Alternatively, the portions 13, 14 and 15 can be formed by a surface, not shown, equipped with runway limiters, not shown.

The respective conveying unit 7 has a powered vehicle 18 of double-tracked and steerable construction, which is disposed with the ability to travel on the runway 8 for conveying of the respective workpiece 4. The powered vehicle 18 has four running-wheel units 19 with respectively two steerable running wheels 20, wherein the respective running-wheel unit 19 can be turned by means of its own steering drive, not shown, around its own vertical steering axis 21. The powered vehicle 18 is an electric vehicle with electric drives, not shown, with which respectively at least one running-wheel unit 19 can be driven. In addition, the powered vehicle 18 may be set up for autonomous driving.

Furthermore, the respective conveying unit 7 has a holding unit 22 carried by the powered vehicle 22 for holding the respective workpiece 4. The holding unit 22 has a holding cantilever arm 23 and a counterweight 24. The counterweight 24 is disposed in such a way relative to the holding cantilever arm 23 that moments acting on the powered vehicle 18 via the holding cantilever arm 23 loaded with the workpiece 4 can be at least balanced out with the counterweight 24. For this purpose, the holding cantilever arm 23 and the counterweight 24 are disposed on sides, situated opposite from one another, of a tower 25 of the holding unit 22. The counterweight 24 is of modular construction and in the shown exemplary embodiment has two weight units 26 stacked one above the other.

The holding cantilever arm 23 is disposed around a horizontal turning axis 27 with the ability to turn on the rest of the holding unit 22a. In addition, the holding cantilever arm 23 has a holding portion 28, which is connected to the workpiece 4 and can be detached from it nondestructively, and, relative to the rest of the holding cantilever arm 23a, is disposed offset laterally from the horizontal turning axis 27. The holding portion 28 has, extending in parallel and spaced apart from one another as well as aligned transversely relative to the horizontal turning axis 27, two crossbeams 31, on which respectively two mushroom pins 29 connected to the workpiece 4 are disposed laterally.

Beyond that, the holding cantilever arm 23 is disposed in a height direction of the tower 25 such that it is vertically displaceable on the rest of the holding unit 22a. In the conveying unit 7 shown on the left in FIG. 1, the holding cantilever arm 23 is situated in its completely lowered position. In the conveying unit 7 shown on the right in FIG. 1, the holding cantilever arm 23 is situated in a raised position.

Furthermore, the holding cantilever arm 23 is disposed around a vertical swivel axis 30 with the ability to swivel on the rest of the holding unit 22a. In comparison to the position of the holding cantilever arm 23 relative to the powered vehicle 18 of the conveying unit 7 shown on the left in FIG. 1, the holding cantilever arm 23 in the conveying unit 7 shown on the right in FIG. 1 is disposed swiveled by 90° around the vertical swivel axis 30. In addition, the holding cantilever arm 23 has been swiveled by 90° around the horizontal turning axis 27. The holding cantilever arm 23 and the counterweight 24 are disposed such that, during a swiveling of the holding cantilever arm 23 around the vertical swivel axis 30, the counterweight 24 is also swiveled simultaneously in the same direction.

In FIG. 1, the holding cantilever arm 23 of the conveying unit 7 shown on the left in FIG. 1 is shown in two turning positions offset from one another by 180°, wherein one turning position, in which the workpiece 4 is disposed outside the dipping bath 6, is shown with solid lines, whereas the other turning position, in which the workpiece 4 is dipped completely into the dipping bath 6, is illustrated by broken lines.

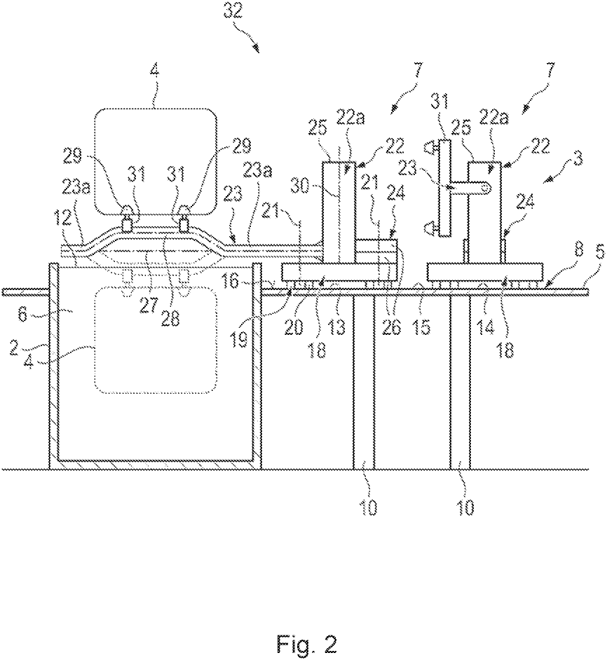

FIG. 2 shows a schematic diagram of a further exemplary embodiment of a dip-coating system 32 according to the invention. The dip-coating system 32 is distinguished from the exemplary embodiment shown in FIG. 1 by the fact that the runway 8 is formed by a shop floor 5 braced by props 10, the dip-coating tank 2 is disposed in partly embedded manner in the shop floor 5 and the tower 25 of the holding unit 22 is disposed in off-centered or peripheral position on the powered vehicle 18. Otherwise, the dip-coating system 32 can be constructed in a manner corresponding to the exemplary embodiment shown in FIG. 1, for which reason reference is made to the above description for FIG. 1 for avoidance of repetitions.

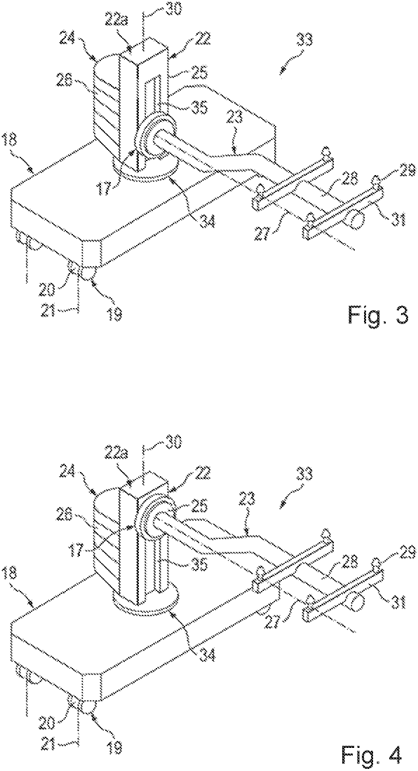

FIG. 3 shows a schematic and perspective diagram of a conveying unit 33 with lowered holding cantilever arm 23 of a further exemplary embodiment of a dip-coating system, not shown, according to the invention. For example, the conveying unit 33 may be used in a dip-coating system 1 corresponding to FIG. 1.

It is obvious that the conveying unit 33 is formed in the manner of a vehicle crane, such as are also the conveying units of FIGS. 1 and 2. For this purpose, the holding unit 22 is connected via a turning unit 34 with the powered vehicle 18 in such a way that it can turn around the vertical swivel axis 30. In addition, the holding unit 22 has a linear guide 35, via which the holding cantilever arm 23 is disposed in vertically displaceable manner on the rest of the holding unit 22a. Beyond that, the holding cantilever arm 23 is connected via a turning unit 17 with the rest of the holding unit 22a in such a way that it can turn around the horizontal turning axis 27. The counterweight 24 is formed from five weight units 26 of identical structure, stacked one above the other, and is disposed on the rest of the holding unit 22a. The holding cantilever arm 23 is shown in its completely lowered position, which corresponds to the lowered position of the holding cantilever arm 23 of the conveying unit shown on the left in FIG. 1. Otherwise, the conveying unit 33 can be constructed in a manner corresponding to the exemplary embodiment shown in FIG. 1, for which reason reference is made to the above description for FIG. 1 for avoidance of repetitions.

FIG. 4 shows a schematic and perspective diagram of the conveying unit 33 shown in FIG. 3 with raised holding cantilever arm 23. For this purpose, by means of the linear guide 35, the holding cantilever arm 23 has been displaced upward relative to the rest of the holding unit 22a.

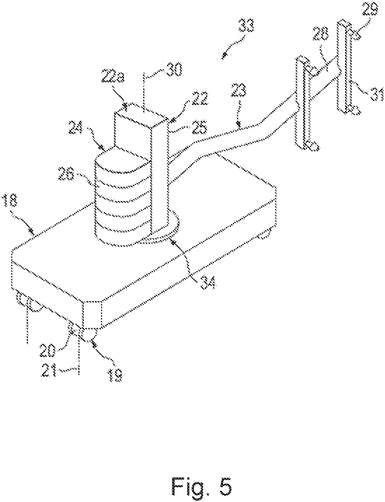

FIG. 5 shows a schematic and perspective diagram of the conveying unit shown in FIG. 3 with horizontally swiveled holding cantilever arm 23. The position of the holding cantilever arm 23 results from the position shown in FIG. 3, wherein the holding cantilever arm 23 has been swiveled by means of the turning unit 17 by 90° around the horizontal turning axis 27 and the holding unit 22 has been turned by means of the turning unit 34 by 90° around the vertical swivel axis 30 relative to the powered vehicle 18. The position of the holding cantilever arm 23 shown in FIG. 5 corresponds to the position of the holding cantilever arm 23 of the conveying unit shown on the right in FIG. 1.

List of reference symbols

| | |
|---|---|
| 1 | Dip-coating system |
| 2 | Dip-coating tank |
| 3 | Conveying system |
| 4 | Workpiece |
| 5 | Shop floor |
| 6 | Dipping bath |
| 7 | Conveying unit |
| 8 | Runway |
| 9 | Platform |
| 10 | Props |
| 11 | Substructure |
| 12 | Surface level of 6 |
| 13 | Conveying portion of 8 |
| 14 | Return portion of 8 |
| 15 | Transition portion of 8 |
| 16 | Surface |
| 17 | Turning unit |
| 18 | Powered vehicle |
| 19 | Running-wheel unit |
| 20 | Running wheel |
| 21 | Vertical steering axis of 19 |
| 22 | Holding unit |
| 22 a | Rest of holding unit |
| 23 | Holding cantilever arm |
| 24 | Counterweight |
| 25 | Tower |
| 26 | Weight unit |
| 27 | Horizontal turning axis of 23 |
| 28 | Holding portion of 23 |
| 29 | Mushroom pins |
| 30 | Vertical swivel axis of 22 |
| 31 | Crossbeams of 23 |
| 32 | Dip-coating system |
| 33 | Conveying unit |
| 34 | Turning unit |
| 35 | Linear guide |

1. A conveying system (3) for a dip-coating system (1, 32), having at least one conveying unit (7, 33), which can be moved parallel to a conveying direction, in which workpieces (4) to be treated can be conveyed through the dip-coating system (1, 32), along a dip-coating tank (2) of the dip-coating system (1, 32), with which unit at least one workpiece (4) to be treated can be moved in the conveying direction and at the same time can be dipped in a dipping bath (6) contained in the dip-coating tank (2), comprising at least one runway (8) that can be disposed laterally beside the dip-coating tank (2), wherein the conveying unit (7, 33) has a powered vehicle (18) of at least double-tracked and steerable construction, which is disposed with the ability to travel on the runway (8) for conveying of the workpiece (8).

2. The conveying system (3) according to claim 1, wherein the powered vehicle (18) is an electric vehicle.

3. The conveying system (3) according to claim 1 , wherein the powered vehicle (18) is set up for autonomous driving.

4. The conveying system (3) according to claim 1, wherein the runway (8) has a conveying portion (13) that can be disposed laterally beside the dip-coating tank (2), a return portion (14) disposed on a side of the conveying portion (13) opposite from the dip-coating tank (2), and two transition portions (15) respectively joining the conveying portion (13) and the return portion (14) end-to-end with one another, wherein these portions (13, 14, 15) of the runway (8) are formed by a surface equipped with runway limiters or by a surface (16) free of runway limiters.

5. The conveying system (3) according to claim 1, wherein the conveying unit (7, 33) has, for holding the workpiece (4) and carried by the powered vehicle (18), at least one holding unit (22), which has at least one holding cantilever arm (23) and at least one counterweight (25), wherein the counterweight (25) is disposed in such a way relative to the holding cantilever arm (23) that moments acting on the powered vehicle (18) via the holding cantilever arm (25) loaded with the workpiece (4) can be at least balanced out with the counterweight (25).

6. The conveying system (3) according to claim 5, wherein the holding cantilever arm (23) is disposed around a horizontal turning axis (27) with the ability to turn on the rest of the holding unit (22a).

7. The conveying system (3) according to claim 6, wherein the holding cantilever arm (23) has a holding portion (28), which is connected to the workpiece (4) and can be detached from it nondestructively, and, relative to the rest of the holding cantilever arm (23a), is disposed laterally offset from the horizontal turning axis (27).

8. The conveying system (3) according to claim 5, wherein at least one mushroom pin (29) that can be connected with the workpiece (4) is disposed laterally on the holding cantilever arm (23).

9. The conveying system (3) according to claim 5, wherein the holding cantilever arm (23) is disposed in vertically displaceable manner on the rest of the holding unit (22a).

10. The conveying system (3) according to claim 5, wherein the holding cantilever arm (23) is disposed around a vertical swivel axis (30) with the ability to swivel on the rest of the holding unit (22a), or the holding unit (22) is disposed around the vertical swivel axis (30) with the ability to turn on the powered vehicle (18).

11. A dip-coating system (1, 32) having at least one dip-coating tank (2) and at least one conveying system (3) for conveying of workpieces (4) to be treated in a conveying direction through the dip-coating system (1, 32), wherein the conveying system (3) is formed according to claim 1 .

12. The dip-coating system (1, 32) according to claim 11, wherein the runway (8) is formed by a shop floor (5) or is braced against the shop floor (5) by means of a load-bearing substructure (11).

13. A method for dip-coating of a workpiece (4), wherein the workpiece (4) to be treated is moved in a conveying direction through the dip-coating system (1, 32) and at the same time is dipped in a dipping bath (6) contained in a dip-coating tank (2), wherein the workpiece (4) to be treated is moved by means of at least one conveying unit (7, 33), which travels on a runway (8) disposed laterally beside the dip-coating tank (2) and has a powered vehicle (18) of at least double-tracked and steerable construction.
